(19) United States
(12) Patent Application Publication
(10) Pub. No.: US 2024/0402764 A1
(43) Pub. Date: Dec. 5, 2024

(54) ELECTRONIC DEVICE AND CONNECTION STRUCTURE

(71) Applicant: Lenovo (Beijing) Limited, Beijing (CN)

(72) Inventors: Guobao JIANG, Beijing (CN); Jiangping WU, Beijing (CN); Lei WANG, Beijing (CN)

(21) Appl. No.: 18/679,905

(22) Filed: May 31, 2024

(30) Foreign Application Priority Data
May 31, 2023 (CN) 202310640443.6

(51) Int. Cl. G06F 1/16

(52) U.S. Cl. CPC G06F 1/1681; G06F 1/1641; G06F 1/1652

(57) ABSTRACT

A connection structure includes a body, a first movement assembly movable relative to the body in a first rotation direction, and a second movement assembly movable relative to the body in a second rotation direction, the second rotational direction being different from the first rotational direction. During a first synchronous movement of the first movement assembly and the second movement assembly, a distance between a connection end of the first movement assembly and a free end of the first movement assembly increases, and a distance between a connection end of the second movement assembly and a free end of the second movement assembly increases.

### CROSS-REFERENCE TO RELATED APPLICATION

This application claims priority to Chinese Patent Application No. 202310640443.6, filed on May 31, 2023, and the entire content of which is incorporated herein by reference.

### TECHNICAL FIELD

The present disclosure relates to the technical field of electronic device technology, and more particularly, to an electronic device and a connection structure.

### BACKGROUND

Currently, various foldable electronic devices, such as foldable mobile phones and foldable tablets, are widely used. It becomes more and more important for these devices to have extensive battery life. To make space for the batteries, the connection structure (such as a folding hinge) between two bodies (or two casings) of foldable devices needs to have a compact size. One obvious solution is to reduce a width of the connection structure. When a flexible screen is on one of the two bodies of a foldable mobile phone, to reduce creases caused by closing the foldable mobile phone on the flexible screen, a connection structure may be used to support the folding of the foldable mobile device. However, the connection structure itself may occupy a larger accommodation space and a wider width.

### SUMMARY

One aspect of the present disclosure provides a connection structure. The connection structure includes: a body; a first movement assembly movable relative to the body in a first rotation direction; and a second movement assembly movable relative to the body in a second rotation direction, the second rotational direction being different from the first rotational direction. During a first synchronous movement of the first movement assembly and the second movement assembly, a distance between a connection end of the first movement assembly and a free end of the first movement assembly increases, and a distance between a connection end of the second movement assembly and a free end of the second movement assembly increases.

Another aspect of the present disclosure provides an electronic device. The electronic device includes: a first body; a second body; and a connection structure. The connection structure includes: a body; a first movement assembly movable relative to the body in a first rotation direction; and a second movement assembly movable relative to the body in a second rotation direction, the second rotational direction being different from the first rotational direction. During a first synchronous movement of the first movement assembly and the second movement assembly, a distance between a connection end of the first movement assembly and a free end of the first movement assembly increases, and a distance between a connection end of the second movement assembly and a free end of the second movement assembly increases.

Another aspect of the present disclosure provides an electronic device. The electronic device includes: a first body; a second body; and a connection structure including a first movement assembly and a second movement assembly. The first body is fixedly connected to a free end of the first movement assembly, the second body is fixedly connected to a free end of the second movement assembly, and the first body rotates relative to the second body through the connection structure. During a first synchronous movement of the first movement assembly and the second movement assembly, a distance between a connection end of the first movement assembly and the free end of the first movement assembly increases, and a distance between a connection end of the second movement assembly and the free end of the second movement assembly increases to form an accommodation space for accommodating a flexible screen when the first body and the second body are in a closed state.

### BRIEF DESCRIPTION OF THE DRAWINGS

To more clearly describe the technical solutions in the embodiments of the present disclosure or related technologies, the accompanying drawings that need to be referenced in the description of the embodiments or the prior art will be briefly described below. Obviously, the drawings in the following description are merely some embodiments of the present disclosure. Those of ordinary skill in the art may also obtain other drawings based on the provided drawings without creative efforts.

FIG. 1 is a schematic diagram of an extended connection structure;

FIG. 2 is a schematic diagram of a folded connection structure;

FIG. 3 is a schematic diagram of another extended connection structure;

FIG. 4 is a schematic diagram of another folded connection structure;

FIG. 5 is a schematic diagram of an extended connection structure according to some embodiments of the present disclosure;

FIG. 6 is a schematic diagram of a folded connection structure according to some embodiments of the present disclosure;

FIG. 7 is a structural diagram of an extended connection structure according to some embodiments of the present disclosure;

FIG. 8 is a structural diagram of a folded connection structure according to some embodiments of the present disclosure;

FIG. 9 is a cross-sectional view of an extended connection structure according to some embodiments of the present disclosure;

FIG. 10 is an exploded view of a connection structure according to some embodiments of the present disclosure;

FIG. 11 is a structural diagram of a first rotation arm and a second rotation arm of a connection structure according to some embodiments of the present disclosure;

FIG. 12 is a structural diagram of a base of a connection structure according to some embodiments of the present disclosure;

FIG. 13 is a structural diagram of a first track member and a first torque arm of a connection structure according to some embodiments of the present disclosure;

FIG. 14 is a structural diagram of a second track member and a second torque arm of a connection structure according to some embodiments of the present disclosure;

FIG. 15 is a schematic diagram of a position of a connection rod of a connection structure according to some embodiments of the present disclosure;

FIG. 16 is a schematic diagram of another position of a connection rod of another connection structure according to some embodiments of the present disclosure;

FIG. 17 is a schematic diagram showing connections between a connection rod and a track member and between a connection rod and a torque arm according to some embodiments of the present disclosure;

FIG. 18 is a schematic diagram of a closed electronic device according to some embodiments of the present disclosure;

FIG. 19 is an exploded view of an electronic device according to some embodiments of the present disclosure; and

FIG. 20 is an exploded view of a rotation shaft of an electronic device according to some embodiments of the present disclosure.

Numerals in the drawings include: a first body 10, a first left-movement component 20, a first right-movement component 30, a second body 40, a second left-movement component 50, a second right-movement component 60, a body 110, a rotation shaft 111, a fixing base 112, a spring 113, a cam 114, a gear 115, a stopper 116, a gasket 117, a buckle 118, a base 119, a first semi-circular groove 119.1, a second semi-circular groove 119.2, a first movement assembly 120, a first track member 121, a first circular groove 121.1, a first sliding groove 121.2, a first track groove 121.3, a first rotation arm 122, a first semi-circular track 122.1, a first circular track 122.2, a first torque arm 123, a first sliding track 123.1, a first connection rod 124, a first fixing block 125, a first spring piece 126, a first pin 127, a first rivet 128, a second movement assembly 130, a second track member 131, a second circular groove 131.1, a second sliding groove 131.2, a second track groove 131.3, a second rotation arm 132, a second semi-circular track 132.1, a second circular track 132.2, a second torque arm 133, a second sliding track 133.1, a second connection rod 134, a second fixing block 135, a second spring piece 136, a second pin 137, a second rivet 138, a support plate 140, a lifting support plate 150, a connection base 160, a first casing 200, a second casing 300, and a flexible screen 400.

### DETAILED DESCRIPTION OF THE EMBODIMENTS

To enable those skilled in the art to better understand the technical solutions in the embodiments of the present disclosure, the technical solutions in the embodiments of the present disclosure will be clearly and completely described below in conjunction with the drawings in the embodiments of the present disclosure. Obviously, the described embodiments are merely some of the embodiments of the present disclosure, not all of them. Based on the embodiments of the present disclosure, all other embodiments obtained by those of ordinary skill in the art without creative efforts fall within the scope of the present disclosure.

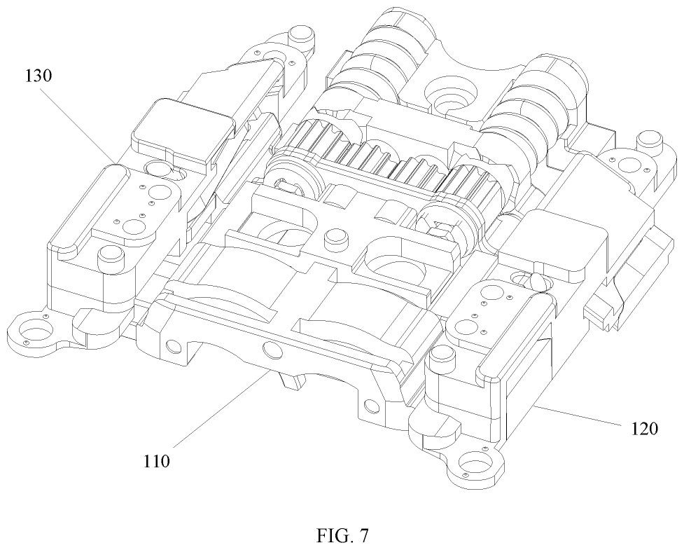

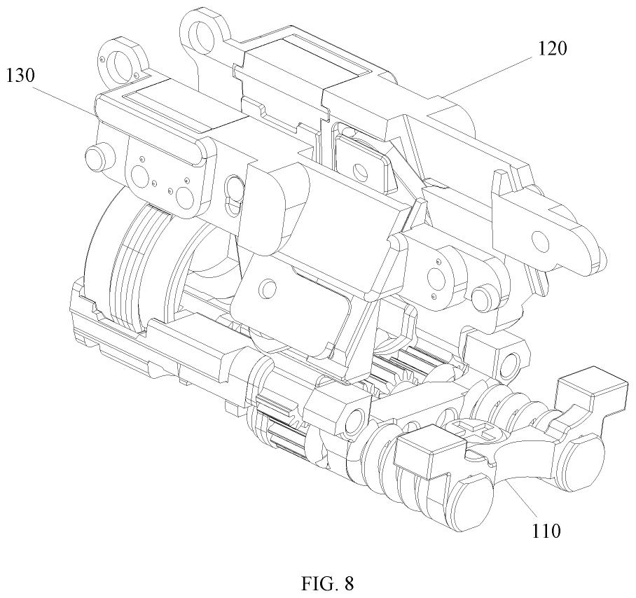

The present disclosure provides a connection structure. As shown in FIG. 7 and FIG. 8, the connection structure includes: a body 110, a first movement assembly 120 configured to move in a first rotation direction relative to the body 110, and a second movement assembly 130 configured to move in a second rotation direction relative to the body 110. The first rotation direction and the second rotation direction are different. During a first synchronous movement of the first movement assembly 120 and the second movement assembly 130, a distance between a connection end of the first movement assembly 120 and a free end of the first movement assembly 120 increases, and a distance between a connection end of the second movement assembly 130 and a free end of the second movement assembly 130 increases.

It should be noted that, as shown in FIG. 8, the first movement assembly 120 moves in the first rotation direction relative to a first side (such as the right side) of the body 110, and the second movement assembly 130 moves in the second rotation direction relative to a second side (such as the left side) of the body 110. The first rotation direction is parallel to the second rotation direction. In addition, the first synchronous movement is a synchronous folding movement. That is, during the synchronous folding movement of the first movement assembly 120 and the second movement assembly 130, the distances between the free end and the connection end of both movement assemblies increase, and the free ends of both movement assemblies are lifted. As such, while a larger accommodation space is obtained, the connection structure may also be made to have a smaller width in an extended state, which helps to reduce both the width of the connection structure and a space occupied by the connection structure.

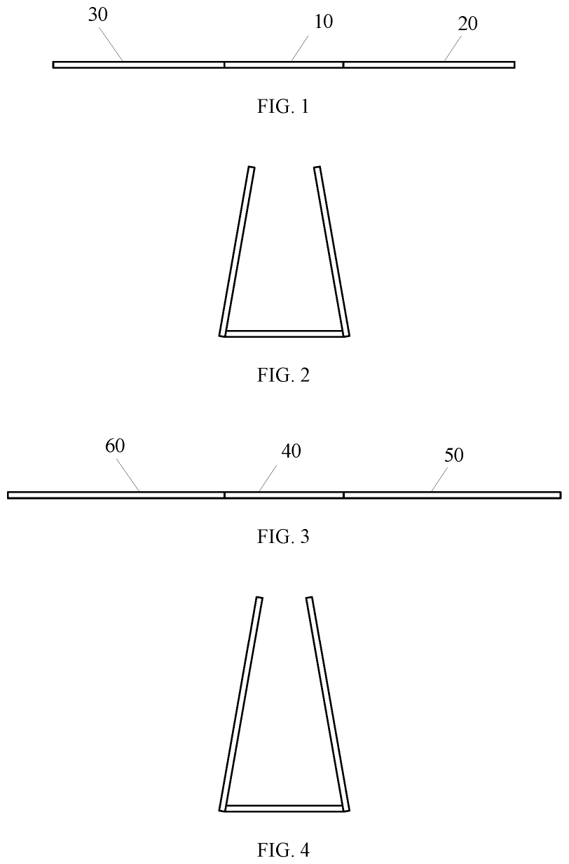

Specifically, to reduce the space occupied by the connection structure is reduced, the connection structures as shown in FIG. 1 and FIG. 2 are illustrated. For example, each movement assembly has the width of a first value. The connection structure occupies a small space in the extended state as shown in FIG. 1, but also forms a small accommodation space in a folded state as shown in FIG. 2. When the connection structure is assembled on bodies of an electronic device, the small accommodation space limits a bending shape of a flexible screen in a folded state, resulting in deeper creases on the flexible screen.

The creases formed by the bending shape of the flexible screen in the folded state of the electronic device need to be reduced. As shown in FIG. 3 and FIG. 4, each movement assembly has the width of a second value. The second value is greater than the first value. As such, the connection structure forms a large accommodation space in the folded state as shown in FIG. 4, but also occupies a large space in the extended state as shown in FIG. 3.

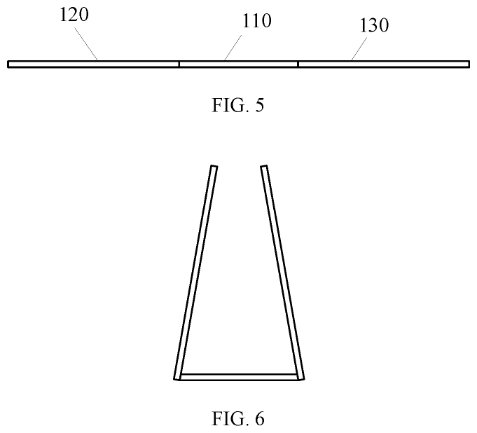

As shown in FIG. 5 and FIG. 6, each movement assembly of the connection structure provided by the embodiments of the present disclosure has the width of the first value. During a folding movement, the two movement assemblies are driven synchronously to form the accommodation space shown in FIG. 6. Because the movement of the two movement assemblies causes each movement assembly to switch from a contracted state (i.e., folded state) to the extended state, the distance from the connection end to the free end of each movement assembly increases, such that the accommodation space shown in FIG. 6 is larger than the accommodation space shown in FIG. 2, and is close to, equal to or larger than the accommodation space shown in FIG. 4. In addition, the connection structure provided by the embodiments of the present disclosure occupies a small space in the extended state (as shown in FIG. 5), which is close to the space shown in FIG. 1 and smaller than the space shown in FIG. 3. That is, the connection structure provided by the present disclosure may not only reduce the space occupied by the connection structure on the bodies of the electronic device, but also enable it to provide more accommodation space formed by the connection structure for a bent portion of the flexible screen of the electronic device. Thus, the creases caused by bending of the flexible screen can be reduced or eliminated.

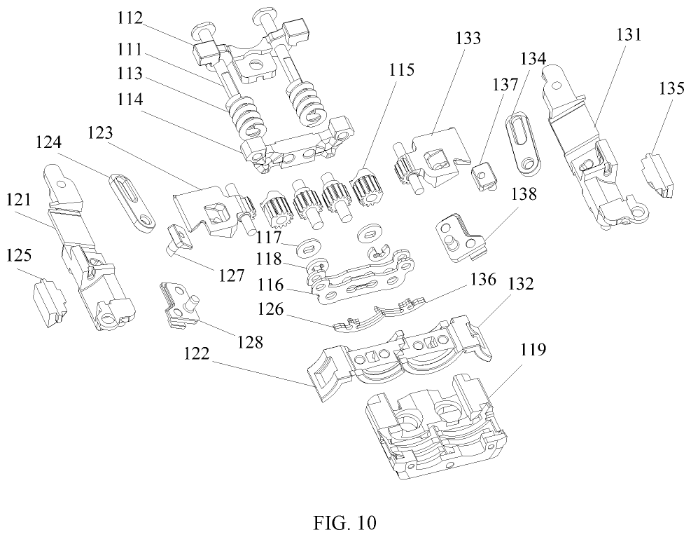

In addition, the connection end of each movement assembly is an end of the movement assembly that rotates around the body 110, and the free end of each movement assembly is a distal end of the movement assembly. In addition, as shown in FIG. 10, the two movement assemblies may achieve a synchronous movement through a gear transmission coupling of the body 110.

That is, in the connection structure provided by the present disclosure, during the synchronous folding movement of the two movement assemblies with a small width, by lifting the free ends of the two movement assemblies, the connection structure may provide a large accommodation space in the folded state. Thus, the connection structure provides both the small width and the large accommodation space.

During a second synchronous movement of the first movement assembly and the second movement assembly, that is, during a synchronous extending movement of the first movement assembly and the second movement assembly, the distance from the connection end to the free end of the first movement assembly decreases and the distance from the connection end to the free end of the second movement assembly decreases. During the synchronous folding movement of the two movement assemblies, the free ends of both movement assemblies are lifted. During the synchronous extending movement of the two movement assemblies, the free ends of both movement assemblies recede to their original positions. In addition, the connection structure provided by the present disclosure may be a folding hinge of a foldable electronic device (e.g., foldable mobile phone).

In the connection structure provided by the embodiments of the present disclosure, during the synchronous folding movement of the two movement assemblies, the connection structure may provide the large accommodation space in the folded state by lifting the free ends of the two movement assemblies. As such, even if the connection structure has the small width, the connection structure may still provide more accommodation space, and may also occupy less space in the extended state.

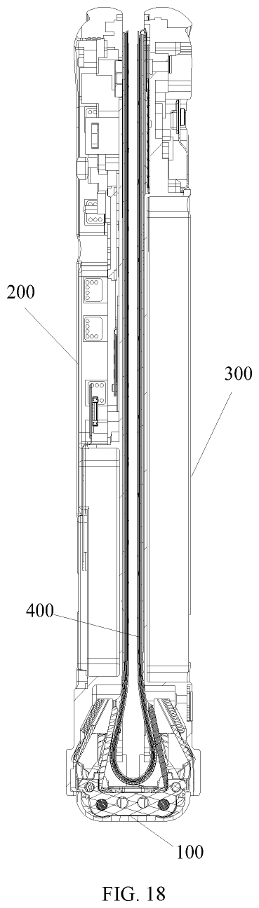

In some embodiments, as shown in FIG. 8, during the first synchronous movement of the first movement assembly 120 and the second movement assembly 130, the first movement assembly 120 and the second movement assembly 130 move from a first relative position to a second relative position. The first movement assembly 120, the second movement assembly 130, and the body 110 together form the accommodation space. The distance from the connection end of the first movement assembly 120 to the free end of the first movement assembly 120 is the largest, and the distance from the connection end of the second movement assembly 130 to the free end of the second movement assembly 130 is the largest too. The first relative position of the first movement assembly 120 and the second movement assembly 130 is an extended position of the first movement assembly 120 and the second movement assembly 130. The second relative position of the first movement assembly 120 and the second movement assembly 130 is a folded position of the first movement assembly 120 and the second movement assembly 130. The accommodation space is approximately a U-shaped accommodation space. When the connection structure is the hinge of the foldable electronic device (such as foldable mobile phone), as shown in FIG. 18, the U-shaped accommodation space may be used to accommodate a water droplet portion of a flexible screen 400. That is, during the synchronous folding movement of the first movement assembly 120 and the second movement assembly 130, when the first movement assembly 120 and the second movement assembly 130 move from the extended position to the folded position, the first movement assembly 120, the second movement assembly 130, and the body 110 together form an approximate U-shaped accommodation space. The free end of each movement assembly is lifted to a maximum height thereof, such that the accommodation space formed by the first movement assembly 120, the second movement assembly 130, and the body 110 is maximized. Thus, a component (e.g., flexible screen 400) may be moved away from the body 110 when being folded to avoid interference between the component and the body 110.

In some embodiments, as shown in FIG. 8 and FIG. 10, the first movement assembly 120 includes: a first rotation component and a first track member 121. A first side of the first rotation component moves in the first rotation direction relative to the first side of the body 110, and a second side of the first rotation component is connected to the first track member 121. The second movement assembly includes: a second rotation component and a second track member 131. A first side of the second rotation component moves in the second rotation direction relative to the second side of the body 110, and a second side of the second rotation component is connected to the second track member 131.

During a first synchronous rotation of the first rotation component and the second rotation component, the first rotation component drives the first track member 121 to rotate while also lifting the first track member 121 along a rotational radial direction. The second rotation component drives the second track member 131 to rotate while also lifting the second track member 131 along the rotational radial direction. That is, during a synchronous folding movement of the two rotation components, each rotation component drives its respective track member to rotate and at the same time lifts its respective track member outward along the rotational radial direction, such that each track member moves further away from the body 110 even if the distance between the connection end and the free end of each movement assembly increases. In addition, the first track member 121 is used to connect with a first body of the foldable electronic device, and the second track member 131 is used to connect with a second body of the foldable electronic device.

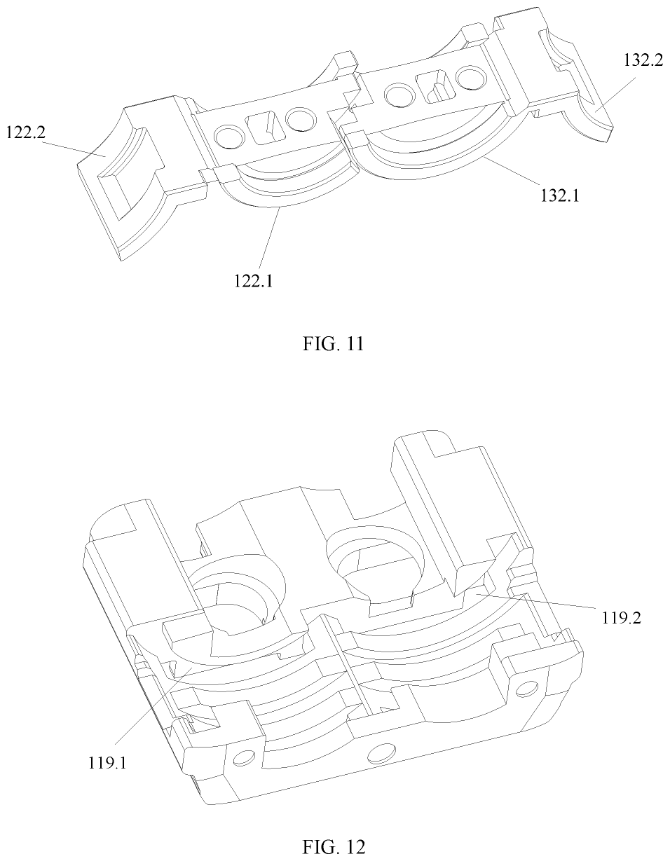

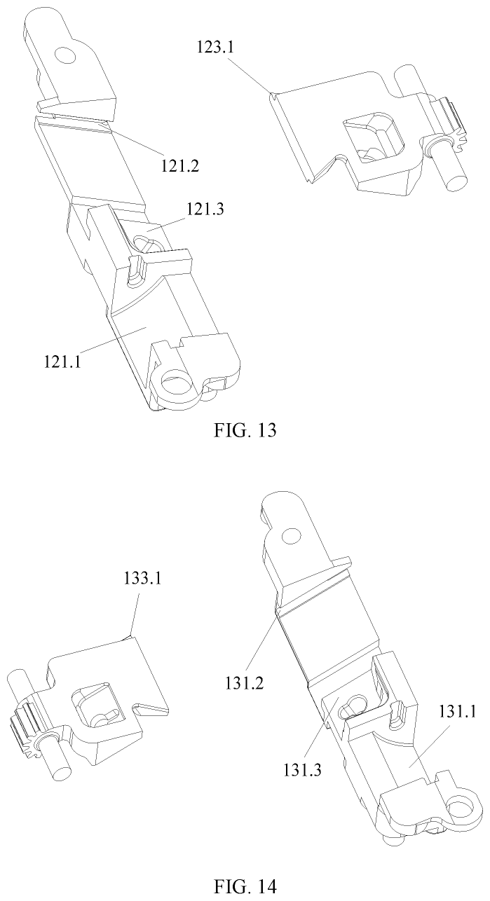

Further, the first rotation component includes: a first rotation member and a first torque member. As shown in FIG. 10, the first rotation member is a first rotation arm 122. A structure of the first rotation arm 122 is shown in FIG. 11. The first torque member is a first torque arm 123, and a structure of the first torque arm 123 is shown in FIG. 13.

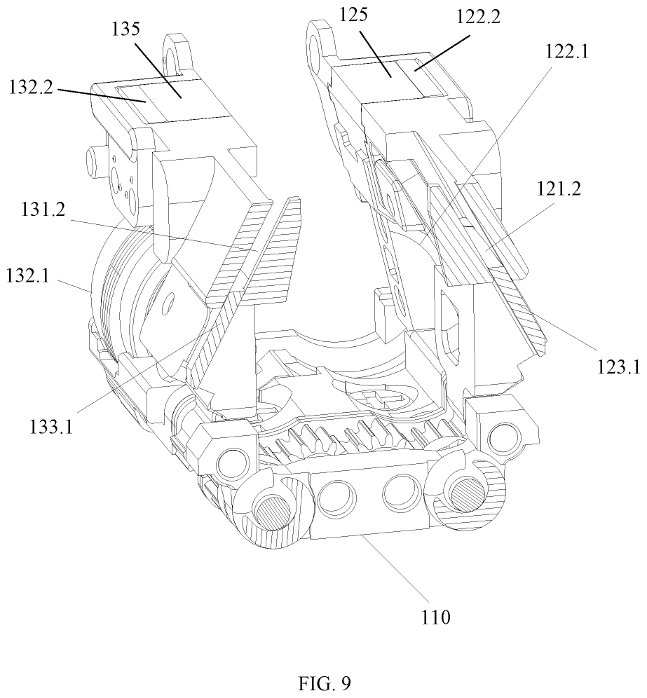

As shown in FIG. 9, a first side of the first rotation member rotates around a first rotation center relative to the first side of the body 110, and a second side of the first rotation member is rotationally connected to the first track member 121. A first side of the first torque member is rotationally connected to the first side of the body 110, and a second side of the first torque member is slidingly connected to the first track member 121. As shown in FIG. 8, the rotational connection between the first side of the first torque member and the first side of the body 110 is a hole-shaft rotational connection.

The first rotation center is higher than a rotation center of the first side of the first torque member such that the first rotation member and the first torque member rotate from the first relative position (i.e., the extended position) to the second relative position (i.e., the folded position). At the same time, the second side of the first rotation member may push the first track member outward along the rotational radial direction. During the above process, the second side of the first torque member and the second track member 131 need to be slidingly connected, and the second side of the first rotation member and the first track member 121 need to be rotationally connected to ensure that the first track member 121 is driven by the first rotation member and the first torque member to rotate normally, thereby avoiding rotational jamming.

The second rotation component includes: a second rotation member and a second torque member. As shown in FIG. 10, the second rotation member is a second rotation arm 132. A structure of the second rotation arm 132 is shown in FIG. 11. The second torque member is a second torque arm 133, and a structure of the second torque arm 133 is shown in FIG. 14.

As shown in FIG. 9, a first side of the second rotation member rotates around a second rotation center relative to the second side of the body 110, and a second side of the second rotation member is rotationally connected to the second track member 131. A first side of the second torque member is rotationally connected to the second side of the body 110, and a second side of the second torque member is slidingly connected to the second track member 131. As shown in FIG. 8, the rotational connection between the first side of the second torque member and the second side of the body 110 is also a hole-shaft rotational connection.

The second rotation center is higher than a rotation center of the first side of the second torque member such that the second rotation member and the second torque member rotate from the first relative position (i.e., the extended position) to the second relative position (i.e., the folded position). At the same time, the second side of the second rotation member may push the second track member outward along the rotational radial direction. During the above process, the second side of the second torque member and the second track member 131 need to be slidingly connected, and the second side of the second rotation member and the second track member 131 need to be rotationally connected to ensure that the second track member 131 is driven by the second rotation member and the second torque member to rotate normally, thereby avoiding rotational jamming.

That is, in each movement assembly, each track member controls the rotation and lifting of the track member through the rotation member and the torque member with a high and a low rotation center respectively. Each track member controls the rotation and lifting of the track member through a height difference between the two rotation centers. Each track member is rotationally connected to the corresponding rotation member, and each track member is slidingly connected to the corresponding torque member to avoid rotational jamming of the track member.

Further, as shown in FIG. 11, the first side of the first rotation member includes a first semi-circular track 122.1, and the second side of the first rotation member includes a first circular track 122.2. As shown in FIG. 13, the first track member 121 is provided with a first circular groove 121.1, and the first circular track 122.2 fits and rotates relative to the first circular groove 121.1. The first circular track 122.2 is a quarter-circular track, and accordingly, the first circular groove 121.1 is a quarter-circular groove. The first circular track 122.2 is installed in the first circular groove 121.1, and rotates relative to the first circular groove 121.1. A first fixing block 125 is engaged with the first track member 121, and includes an arc surface at its bottom in parallel with an arc surface of the first circular groove 121.1. The first circular track 122.2 is installed in the first circular groove 121.1 through the first fixing block 125. That is, the first circular track 122.2 rotates between the first fixing block 125 and the first circular groove 121.1. As shown in FIG. 13, a second side of the first torque member includes a first sliding track 123.1, and the first track member 121 includes a first sliding groove 121.2 to couple with the first sliding track 123.1. The first sliding track 123.1 is a first linear sliding track, and the first sliding groove 121.2 is a first linear groove to couple with the first linear sliding track, such that the first track member 121 can slide relative to the second side of the first torque member while rotating relative to the second side of the first torque member. A sliding direction of the first track member 121 is consistent with a rotational radial direction in which the second side of the first torque member rotates.

As shown in FIG. 11, the first side of the second rotation member includes a second semi-circular track 132.1, and the second side of the second rotation member includes a second circular track 132.2. As shown in FIG. 14, the second track member 131 includes a second circular groove 131.1, and the second circular track 132.2 fits and rotates relative to the second circular groove 131.1. The second circular track 132.2 is a quarter-circular track, and accordingly, the second circular groove 131.1 is a quarter-circular groove. The second circular track 132.2 is installed in the second circular groove 131.1, and rotates relative to the second circular groove 131.1. A second fixing block 135 is engaged with the second track member 131, includes an arc surface at its bottom in parallel with an arc surface of the second circular groove 131.1. The second circular track 132.2 is installed in the second circular groove 131.1 through the second fixing block 135. That is, the second circular track 132.2 rotates between the second fixing block 135 and the second circular groove 131.1. As shown in FIG. 14, a second side of the second torque member includes a second sliding track 133.1, and the second track member 131 includes a second sliding groove 131.2. The second sliding track 133.1 is a second linear sliding track, and the second sliding groove 131.2 is a second linear sliding groove to couple with the second linear sliding track, such that the second track member 131 can slide relative to the second side of the second torque member while rotating relative to the second side of the second torque member. A sliding direction of the second track member 131 is consistent with a rotational radial direction in which the second side of the second torque member rotates.

To further optimize the above technical solution, as shown in FIG. 12, the first side of the body 110 (i.e., base 119) includes a first semi-circular groove 119.1. The first semi-circular track 122.1 is installed in the first semi-circular groove 119.1 and rotates around the first rotation center. The second side of the body 110 (i.e., base 119) includes a second semi-circular groove 119.2. The second semi-circular track 132.1 is installed in the second semi-circular groove 119.2 and rotates around the second rotation center.

As shown in FIG. 7, in the first relative position (i.e., the extended position), the first semi-circular track 122.1 is in the extended state and is accommodated in the first semi-circular groove 119.1. The second semi-circular track 132.1 is in the extended state and is accommodated in the second semi-circular groove 119.2. The first sliding track 123.1 is accommodated in the first sliding groove 121.2. The second sliding track 133.1 is accommodated in the second sliding groove 131.2. As such, the connection structure in the extended state has the characteristics of compact structure and suitable structural layout.

As shown in FIG. 9, in the second relative position (i.e., the folded position), the first semi-circular track 122.1 is in an exposed (102°) state and is partially exposed to the first semi-circular groove 119.1. The second semi-circular track 132.1 is also in the exposed (102°) state and is partially exposed to the second semi-circular groove 119.2. A portion of the first sliding groove 121.2 slides out of the first sliding track 123.1, and a portion of the second sliding groove 131.2 slides out of the second sliding track 133.1. That is, in the second relative position, the semi-circular track of each rotation member rotates around its rotation center relative to its respective semi-circular groove to 102°. Each rotation member is disposed at the base 119. A portion of each track member slides away from the second side of the respective torque member to ensure that each track member is smoothly lifted by the respective rotation member.

In some embodiments, when the movement assemblies rotate to the second relative position, as shown in FIG. 9, the sliding track of each torque member and the sliding groove of each track member are less overlapped by only a small amount. In this case, the sliding connection between the torque member and the track member may wobble, thereby affecting stability of the connection structure. To solve the above problem, it is necessary to limit the sliding between the torque member and the track member to increase the amount of sliding overlap between the torque member and the track member to avoid wobbling of the two.

Therefore, as shown in FIG. 10, the first movement assembly also includes a first connection rod 124.

A first end of the first connection rod 124 is movably connected to the first track member 121. A second end of the first connection rod 124 is movably connected to the second side of the first torque member. The first end of the first connection rod 124 may slide relative to the second side of the first torque member along the first track member 121.

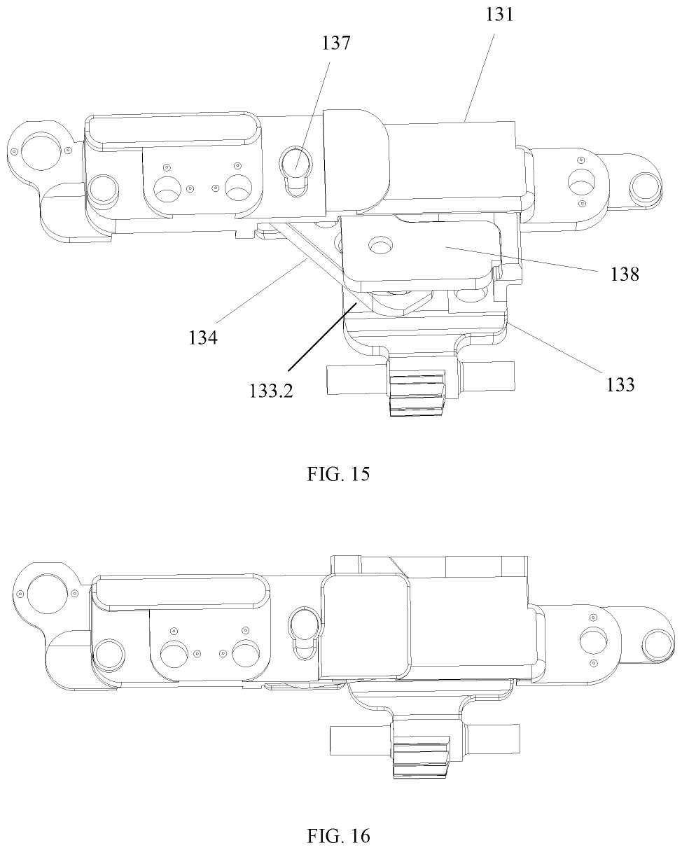

As shown in FIG. 15, the second movement assembly also includes a second connection rod 134.

A first end of the second connection rod 134 is movably connected to the second track member 131. A second end of the second connection rod is movably connected to the second side of the second torque member. The first end of the second connecting rod 134 may slide relative to the second side of the second torque member along the second track member 131.

For example, the first end of the first connection rod 124 is rotatably connected to the first track member 121, and the second end of the first connection rod 124 is slidingly connected to the second side of the first torque member. The second end of the first connection rod 124 slides in a direction consistent with the rotational radial direction of the first end of the first connection rod 124, such that the first end of the first connection rod 124 can slide relative to the second side of the first torque member along the first track member 121.

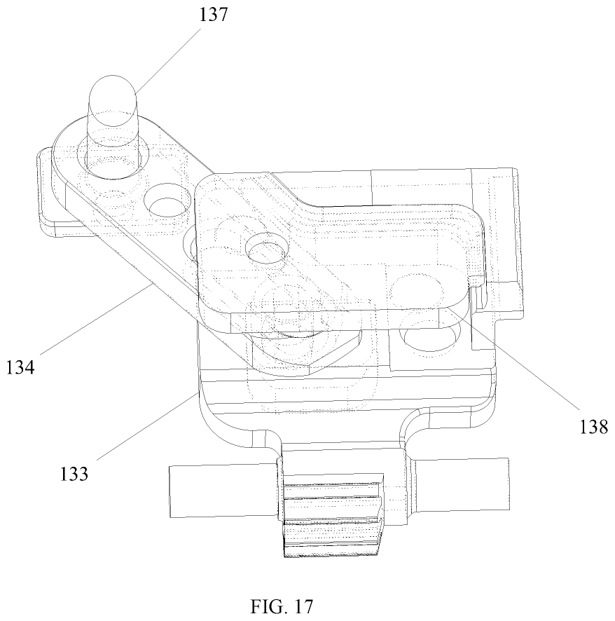

As shown in FIG. 15, the first end of the second connection rod 134 is rotatably connected to the second track member 131, and the second end of the second connection rod 134 is slidingly connected to the second side of the second torque member. The second end of the second connection rod 134 slides in a direction consistent with the rotational radial direction of the first end of the second connection rod 134, such that the first end of the second connection rod 134 can slide relative to the second side of the second torque member along the second track member 131. As shown in FIG. 15 and FIG. 17, the first end of the second connection rod 134 includes a round hole. A second pin 137 is rotationally connected to the second track member 131. The first end of the second connection rod 134 is rotatable relative to the second pin 137. The second end of the second connection rod 134 includes a waist-shaped sliding groove, and is slidably connected to the second side of the second torque member through a second rivet 138. The second end of the second connection rod 134 is rotatable relative to the second rivet 138. The first connection rod 124 is arranged in the same manner and will not be described herein. In other words, connection relationship of each connection rod is designed in this way, which seamlessly and conveniently limits the sliding of each connection rod.

Further, the first connection rod 124 is arranged in parallel between the first sliding groove 121.2 of the first track member 121 and the first sliding track 123.1 of the first torque member.

Additionally, and alternatively, as shown in FIG. 15, the second connection rod 134 is arranged in parallel between the second sliding groove 131.2 of the second track member 131 and the second sliding track 133.1 of the second torque member. In the embodiments of the present disclosure, the design makes the structure of each movement assembly more compact.

Further, as shown in FIG. 13, the first track member 121 includes a first track groove 121.3 arranged in parallel with the first sliding groove 121.2.

A first torque groove is provided on a bottom surface of the first torque member for slidingly coupling with the first track member 121, and the first track groove 121.3 is parallel with the first torque groove. The first end of the first connection rod 124 is rotatably connected to the first track groove 121.3 through a first pin 127. The second end of the first connection rod 124 is slidably connected to the first torque groove through a first rivet 128.

As shown in FIG. 14, the second track member 131 includes a second track groove 131.3 arranged in parallel with the second sliding groove 131.2.

As shown in FIG. 15, a second torque groove 133.2 is provided on a bottom surface of the second torque member for slidingly coupling with the second track member 131, and the second track groove 131.3 is parallel with the second torsion groove 133.2. The first end of the second connection rod 134 is rotatably connected to the second track groove 131.3 through the second pin 137. The second end of the second connection rod 134 is slidably connected to the second torque groove 133.2 through the second rivet 138.

As shown in FIG. 10, the waist-shaped sliding groove at the second end of the second connection rod 134 is a hollow sliding groove arranged along its length direction. The waist-shaped sliding groove at the second end of the first connection rod 124 is a hollow sliding groove arranged along its length direction. As shown in FIG. 15, in the second relative position, the second connection rod 134 is exposed to the second track groove 131.3 and the second torque groove 133.2. As shown in FIG. 16, in the first relative position, the second connection rod 134 is accommodated in the second track groove 131.3 and the second torque groove 133.2.

The present disclosure also provides an electronic device. As shown in FIGS. 18 to 20, the electronic device includes: a first body, a second body, and a connection structure including a first movement assembly 120 and a second movement assembly 130. The first body is fixedly connected to a free end of the first movement assembly 120, and the second body is fixedly connected to a free end of the second movement assembly 130. The first body rotates relative to the second body through the connection structure.

During a first synchronous movement of the first movement assembly 120 and the second movement assembly 130, a distance between a connection end of the first movement assembly 120 and the free end of the first movement assembly 120 increases, and a distance between a connection end of the second movement assembly 130 and the free end of the second movement assembly 130 increases to form an accommodation space for accommodating a flexible screen 400 when the first body and the second body are in a closed state.

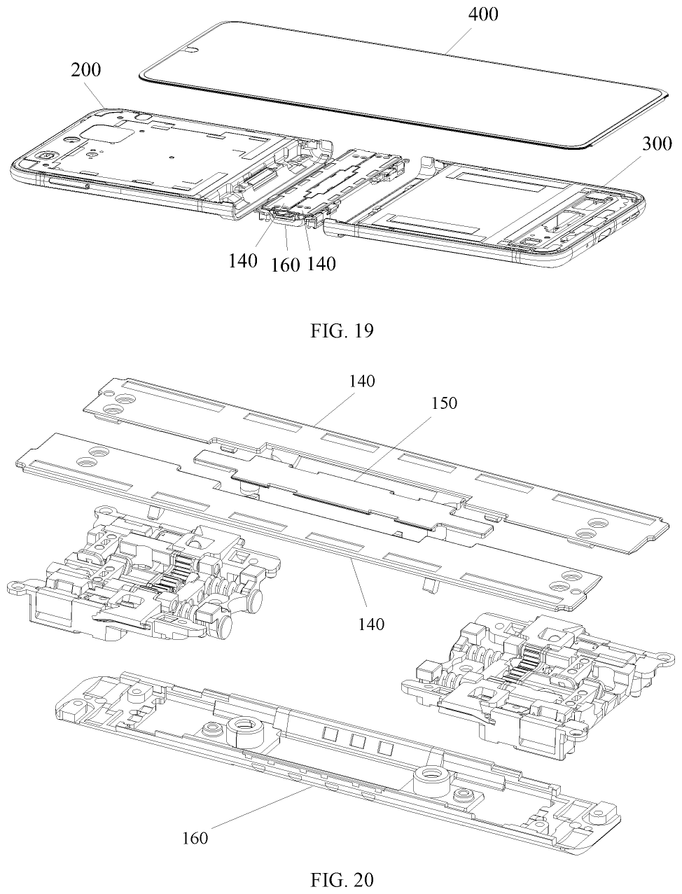

It should be noted that the electronic device may be a foldable electronic device, such as a foldable mobile phone. Correspondingly, as shown in FIG. 19, the first body may be a first casing 200 and the second body may be a second casing 300. The first synchronous movement is a synchronous folding movement. During the synchronous folding movement of the first movement assembly 120 and the second movement assembly 130, the distance between the free end and the connection end of each of the two movement assemblies increases. That is, the free end of each movement assembly is lifted. As such, the first body and the second body are both lifted when they are in the closed state. The flexible screen 400 is also lifted. A larger accommodation space is provided for the flexible screen 400, thereby preventing the flexible screen 400 and a base of the electronic device from interfering from each other. Based on this design, the connection structure has a smaller width in an extended state. Thus, the width of the connection structure is reduced and the space occupied by the connection structure is also reduce.

Each embodiment in this specification is described in a progressive manner. Each embodiment focuses on its differences from other embodiments. The same and similar parts between various embodiments can be referred to each other.

The description of the disclosed embodiments enables those skilled in the art to implement or use the present disclosure. Various modifications to these embodiments will be readily apparent to those skilled in the art, and the generic principles defined herein may be practiced in other embodiments without departing from the spirit or scope of the present disclosure. Thus, the present disclosure is not intended to be limited to the embodiments shown herein but is to be accorded the broadest scope consistent with the principles and inventive features disclosed herein.

What is claimed is:

1. A connection structure, comprising:
a body;
a first movement assembly movable relative to the body in a first rotation direction; and
a second movement assembly movable relative to the body in a second rotation direction, the second rotational direction being different from the first rotational direction;
wherein during a first synchronous movement of the first movement assembly and the second movement assembly, a distance between a connection end of the first movement assembly and a free end of the first movement assembly increases, and a distance between a connection end of the second movement assembly and a free end of the second movement assembly increases.

2. The connection structure according to claim 1, wherein:
during the first synchronous movement of the first movement assembly and the second movement assembly, the first movement assembly and the second movement assembly move from a first relative position to a second relative position;
the first movement assembly, the second movement assembly, and the body together form an accommodation space; and
the distance between the connection end of the first movement assembly and the free end of the first movement assembly reaches its maximum, and the distance between the connection end of the second movement assembly and the free end of the second movement assembly reaches its maximum.

3. The connection structure according to claim 2, wherein:
the first movement assembly includes a first rotation component and a first track member;
a first side of the first rotation component moves in the first rotation direction relative to a first side of the body, and a second side of the first rotation component is connected to the first track member;
the second movement assembly includes a second rotation component and a second track member;
a first side of the second rotation component moves in the second rotation direction relative to the second side of the body, and a second side of the second rotation component is connected to the second track member; and
during a first synchronous rotation of the first rotation component and the second rotation component, the first rotation component drives the first track member to rotate while also lifting the first track member along a rotational radial direction, and the second rotation component drives the second track member to rotate while also lifting the second track member along the rotational radial direction.

4. The connection structure according to claim 3, wherein:
the first rotation component includes a first rotation member and a first torque member;
a first side of the first rotation member rotates around a first rotation center relative to the first side of the body, and a second side of the first rotation member is rotationally connected to the first track member; a first side of the first torque member is rotationally connected to the first side of the body, and a second side of the first torque member is slidingly connected to the first track member, wherein the first rotation center is higher than a rotation center of the first side of the first torque member;
the second rotation component includes: a second rotation member and a second torque member; and
a first side of the second rotation member rotates around a second rotation center relative to the second side of the body, and a second side of the second rotation member is rotationally connected to the second track member; a first side of the second torque member is rotationally connected to the second side of the body, and a second side of the second torque member is slidingly connected to the second track member; wherein the second rotation center is higher than a rotation center of the first side of the second torque member.

5. The connection structure according to claim 4, wherein:
the first side of the first rotation member includes a first semi-circular track, the second side of the first rotation member includes a first circular track, the first track member includes a first circular groove, and the first circular track fits and rotates relative to the first circular groove; a second side of the first torque member includes a first sliding track, and the first track member includes a first sliding groove to couple with the first sliding track; and
the first side of the second rotation member includes a second semi-circular track, the second side of the second rotation member includes a second circular track, the second track member includes a second circular groove, and the second circular track fits and rotates relative to the second circular groove; a second side of the second torque member includes a second sliding track, and the second track member includes a second sliding groove to couple with the second sliding track.

6. The connection structure according to claim 5, wherein:
the first side of the body includes a first semi-circular groove, and the first semi-circular track is installed in the first semi-circular groove and rotates around the first rotation center; the second side of the body includes a second semi-circular groove, and the second semi-circular track is installed in the second semi-circular groove and rotates around the second rotation center;
in the first relative position, the first semi-circular track is in the extended state and is accommodated in the first semi-circular groove, the second semi-circular track is in the extended state and is accommodated in the second semi-circular groove, the first sliding track is accommodated in the first sliding groove, and the second sliding track is accommodated in the second sliding groove; and
in the second relative position, the first semi-circular track is in an exposed state and is partially exposed to the first semi-circular groove, the second semi-circular track is also in the exposed state and is partially exposed to the second semi-circular groove, a portion of the first sliding groove slides out of the first sliding track, and a portion of the second sliding groove slides out of the second sliding track.

7. The connection structure according to claim 6, wherein:
the first movement assembly further includes a first connection rod;
a first end of the first connection rod is movably connected to the first track member, a second end of the first connection rod is movably connected to the second side of the first torque member, and the first end of the first connection rod slides relative to the second side of the first torque member along the first track member;
the second movement assembly also includes a second connection rod; and
a first end of the second connection rod is movably connected to the second track member, a second end of the second connection rod is movably connected to the second side of the second torque member, and the first end of the second connecting rod slides relative to the second side of the second torque member along the second track member.

8. The connection structure according to claim 7, wherein:
the first end of the first connection rod is rotatably connected to the first track member, and the second end of the first connection rod is slidingly connected to the second side of the first torque member; wherein the second end of the first connection rod slides in a direction consistent with the rotational radial direction of the first end of the first connection rod; and
the first end of the second connection rod is rotatably connected to the second track member, and the second end of the second connection rod is slidingly connected to the second side of the second torque member, wherein the second end of the second connection rod slides in a direction consistent with the rotational radial direction of the first end of the second connection rod.

9. The connection structure according to claim 8, wherein:
the first connection rod is arranged in parallel between the first sliding groove of the first track member and the first sliding track of the first torque member; and/or
the second connection rod is arranged in parallel between the second sliding groove of the second track member and the second sliding track of the second torque member.

10. An electronic device, comprising:
a first body;
a second body; and
a connection structure;
wherein the connection structure includes:
a body;
a first movement assembly movable relative to the body in a first rotation direction; and
a second movement assembly movable relative to the body in a second rotation direction, the second rotational direction being different from the first rotational direction;
wherein during a first synchronous movement of the first movement assembly and the second movement assembly, a distance between a connection end of the first movement assembly and a free end of the first movement assembly increases, and a distance between a connection end of the second movement assembly and a free end of the second movement assembly increases.

11. The electronic device according to claim 10, wherein:
during the first synchronous movement of the first movement assembly and the second movement assembly, the first movement assembly and the second movement assembly move from a first relative position to a second relative position;
the first movement assembly, the second movement assembly, and the body together form an accommodation space; and
the distance between the connection end of the first movement assembly and the free end of the first movement assembly reaches its maximum, and the distance between the connection end of the second movement assembly and the free end of the second movement assembly reaches its maximum.

12. The electronic device according to claim 11, wherein:
the first movement assembly includes a first rotation component and a first track member;
a first side of the first rotation component moves in the first rotation direction relative to a first side of the body, and a second side of the first rotation component is connected to the first track member;
the second movement assembly includes a second rotation component and a second track member;
a first side of the second rotation component moves in the second rotation direction relative to the second side of the body, and a second side of the second rotation component is connected to the second track member; and
during a first synchronous rotation of the first rotation component and the second rotation component, the first rotation component drives the first track member to rotate while also lifting the first track member along a rotational radial direction, and the second rotation component drives the second track member to rotate while also lifting the second track member along the rotational radial direction.

13. The electronic device according to claim 12, wherein:
the first rotation component includes a first rotation member and a first torque member;
a first side of the first rotation member rotates around a first rotation center relative to the first side of the body, and a second side of the first rotation member is rotationally connected to the first track member; a first side of the first torque member is rotationally connected to the first side of the body, and a second side of the first torque member is slidingly connected to the first track member, wherein the first rotation center is higher than a rotation center of the first side of the first torque member;
the second rotation component includes: a second rotation member and a second torque member; and
a first side of the second rotation member rotates around a second rotation center relative to the second side of the body, and a second side of the second rotation member is rotationally connected to the second track member; a first side of the second torque member is rotationally connected to the second side of the body, and a second side of the second torque member is slidingly connected to the second track member; wherein the second rotation center is higher than a rotation center of the first side of the second torque member.

14. The electronic device according to claim 13, wherein:
the first side of the first rotation member includes a first semi-circular track, the second side of the first rotation member includes a first circular track, the first track member includes a first circular groove, and the first circular track fits and rotates relative to the first circular groove; a second side of the first torque member includes a first sliding track, and the first track member includes a first sliding groove to couple with the first sliding track; and
the first side of the second rotation member includes a second semi-circular track, the second side of the second rotation member includes a second circular track, the second track member includes a second circular groove, and the second circular track fits and rotates relative to the second circular groove; a second side of the second torque member includes a second sliding track, and the second track member includes a second sliding groove to couple with the second sliding track.

15. The electronic device according to claim 14, wherein:
the first side of the body includes a first semi-circular groove, and the first semi-circular track is installed in the first semi-circular groove and rotates around the first rotation center; the second side of the body includes a second semi-circular groove, and the second semi-circular track is installed in the second semi-circular groove and rotates around the second rotation center;
in the first relative position, the first semi-circular track is in the extended state and is accommodated in the first semi-circular groove, the second semi-circular track is in the extended state and is accommodated in the second semi-circular groove, the first sliding track is accommodated in the first sliding groove, and the second sliding track is accommodated in the second sliding groove; and
in the second relative position, the first semi-circular track is in an exposed state and is partially exposed to the first semi-circular groove, the second semi-circular track is also in the exposed state and is partially exposed to the second semi-circular groove, a portion of the first sliding groove slides out of the first sliding track, and a portion of the second sliding groove slides out of the second sliding track.

16. The electronic device according to claim 15, wherein:
the first movement assembly further includes a first connection rod;
a first end of the first connection rod is movably connected to the first track member, a second end of the first connection rod is movably connected to the second side of the first torque member, and the first end of the first connection rod slides relative to the second side of the first torque member along the first track member;
the second movement assembly also includes a second connection rod; and
a first end of the second connection rod is movably connected to the second track member, a second end of the second connection rod is movably connected to the second side of the second torque member, and the first end of the second connecting rod slides relative to the second side of the second torque member along the second track member.

17. The electronic device according to claim 16, wherein:
the first end of the first connection rod is rotatably connected to the first track member, and the second end of the first connection rod is slidingly connected to the second side of the first torque member; wherein the second end of the first connection rod slides in a direction consistent with the rotational radial direction of the first end of the first connection rod; and
the first end of the second connection rod is rotatably connected to the second track member, and the second end of the second connection rod is slidingly connected to the second side of the second torque member, wherein the second end of the second connection rod slides in a direction consistent with the rotational radial direction of the first end of the second connection rod.

18. The electronic device according to claim 17, wherein:
the first connection rod is arranged in parallel between the first sliding groove of the first track member and the first sliding track of the first torque member; and/or
the second connection rod is arranged in parallel between the second sliding groove of the second track member and the second sliding track of the second torque member.

19. An electronic device, comprising:
a first body;
a second body; and
a connection structure including a first movement assembly and a second movement assembly;
wherein:
the first body is fixedly connected to a free end of the first movement assembly, the second body is fixedly connected to a free end of the second movement assembly, and the first body rotates relative to the second body through the connection structure; and
during a first synchronous movement of the first movement assembly and the second movement assembly, a distance between a connection end of the first movement assembly and the free end of the first movement assembly increases, and a distance between a connection end of the second movement assembly and the free end of the second movement assembly increases to form an accommodation space for accommodating a flexible screen when the first body and the second body are in a closed state.
